(19) United States
(12) Patent Application Publication
(10) Pub. No.: US 2017/0366212 A1
(43) Pub. Date: Dec. 21, 2017

(54) MOBILE DEVICE WITH DUAL EMBEDDED WIRELESS RADIOS

(71) Applicant: Virtual Imaging, Inc., Boca Raton, FL (US)

(72) Inventor: Peter M. Chicchetti, Coral Springs, FL (US)

(21) Appl. No.: 15/623,214

(22) Filed: Jun. 14, 2017

Related U.S. Application Data
(60) Provisional application No. 62/350,939, filed on Jun. 16, 2016.

(51) Int. Cl. H04B 1/38; H04W 88/06; H04W 84/12

(52) U.S. Cl. CPC H04B 1/38; H04W 84/12; H04W 88/06

(57) ABSTRACT

A mobile processing device includes a first internally installed wireless interface that communicates with an external device, a second internally installed wireless interface that communicates with a network, where the first internally installed wireless interface acquires data from the external device and the second internally installed wireless interface transmits the acquired data to the network, wherein acquisition of the data and transmission of the acquired data occur in parallel.

### CROSS-REFERENCE TO RELATED APPLICATIONS

This application claims the benefit of U.S. Provisional Application No. 62/350,939, which was filed on Jun. 16, 2016, which is hereby incorporated by reference in its entirety.

### BACKGROUND

### Field

Aspects of the present disclosure generally relate to wirelessly transmitting and receiving data using a plurality of internal wireless adapters and more specifically to transmitting and receiving data simultaneously using the plurality of internal wireless adapters.

### Description of the Related Art

Mobile processing devices such as laptops and tablets are currently configured to include a single internal Wireless Fidelity (Wi-Fi®) radio (hereinafter referred to as “wireless adapter”) that enable the mobile processing devices to connect to various networks. In some instances, the single internal wireless adapter is single band, e.g., 2.4 Ghz or 5 Ghz wireless capability. In some instances, the single internal wireless adapter is dual band, e.g., includes both 2.4 Ghz and 5 Ghz wireless capabilities.

In the case of a single band internal wireless adapter, in order for a mobile processing device containing such an adapter to be able to communicate with, for example, both a wireless network and another device that supports wireless communication, the single band internal wireless adapter must be shared by the wireless network and the other device, which results in a sequential operation by the mobile processing device when handling data to be shared between the wireless network and the other device.

For example, current wireless X-ray systems include a mobile processing device, e.g., notebook, tablet, etc., with a single dual band internal wireless adapter wirelessly connected to both a wireless X-ray detector and a wireless network where the X-ray system is located, e.g., hospital wireless network. Both the wireless X-ray detector and the hospital's wireless network must share the mobile processing device's single dual band internal wireless adapter. This requires that acquiring images from the wireless X-ray detector and sending them to the hospital's wireless network must occur sequentially. For instance, if 10 X-ray images of a patient are to be obtained, all 10 images would need to be obtained first and then the images would be sent to the hospital's wireless network.

A delay such as this results in a slowdown of the overall patient treatment workflow since an X-ray technologist operating the mobile processing device would only be able to connect the mobile processing device to either the wireless X-ray detector or the hospital's wireless network at any given time. For example, in a trauma situation, where providing patient care is time critical, it is important that X-ray images be taken, acquired, and made available for review as quickly and efficiently as possible.

In the case of a dual band internal wireless adapter, a mobile processing device containing such an adapter can connect to a wireless network via one band, e.g., 5 GHz, and another device that supports wireless communication via the other band, i.e., 2.4 GHz. However, while the dual band internal wireless adapter can use either band, it cannot use both bands at the same time. As such, replacing the single band internal wireless adapter in the above-described wireless X-ray system with a dual band internal wireless adapter would result in the same data transmission issue.

What is needed is mobile processing device equipped with dual internal wireless adapters where one internal wireless adapter is configured to communicate with, for example, a wirelessly enabled device, such as a wireless X-ray detector, and the second internal wireless adapter is configured to communicate with, for example, a wireless network, such as a hospital's wireless network, where the mobile processing device simultaneously communicates with the wirelessly enabled device and the wireless network.

### SUMMARY

At least one aspect of the present disclosure generally relates to providing a mobile processing device with at least two internal wireless adapters where the mobile processing device simultaneously communicates with different entities using the at least two internal wireless adapters.

An aspect of the present disclosure generally relates to a mobile processing device comprising a first wireless interface, installed internally in the mobile processing device, in communication with an external device, a second wireless interface, installed internally in the mobile processing device, in communication with a network, and a control unit that controls the first wireless interface to acquire data from the external device and the second wireless interface to transmit the acquired data to the network, wherein acquisition of the data and transmission of the acquired data occur in parallel.

### BRIEF DESCRIPTION OF THE DRAWINGS

The accompanying drawings, which are incorporated in and constitute a part of the specification, illustrate exemplary embodiments of the disclosure and, together with the description, serve to explain the principles of the disclosure.

FIG. 1 is a representational view illustrating a general configuration of a system according to an exemplary embodiment.

FIG. 2 is block diagram illustrating a general configuration of the internal architecture of a mobile processing device according to an exemplary embodiment.

FIGS. 3A-3C are block diagrams illustrating configurations for interfacing a second wireless interface adapter according to an exemplary embodiment.

FIG. 4 is a block diagram illustrating a general configuration of a mobile processing device with two internal wireless interface adapters according to an exemplary embodiment.

FIG. 5 is a block diagram illustrating a general configuration of a mobile processing device with two internal wireless interface adapters according to an exemplary embodiment.

FIG. 6 is a block diagram illustrating a general configuration of a mobile processing device with two internal wireless interface adapters according to an exemplary embodiment.

FIG. 7 is illustrates a general data and control flow of the system according to an exemplary embodiment.

FIG. 8 illustrates a data and control flow between the mobile processing device and another device using an internal wireless interface adapter according to an exemplary embodiment.

FIG. 9 illustrates a data storage flow of the system according to an exemplary embodiment.

FIG. 10 illustrates a workflow of the system according to an exemplary embodiment.

FIG. 11 illustrates a flow for obtaining hardcopies of data according to an exemplary embodiment.

FIG. 12 illustrates a data acquisition and transmission process according to an exemplary embodiment.

### DETAILED DESCRIPTION OF THE INVENTION

Exemplary embodiments are described below with reference to the drawings.

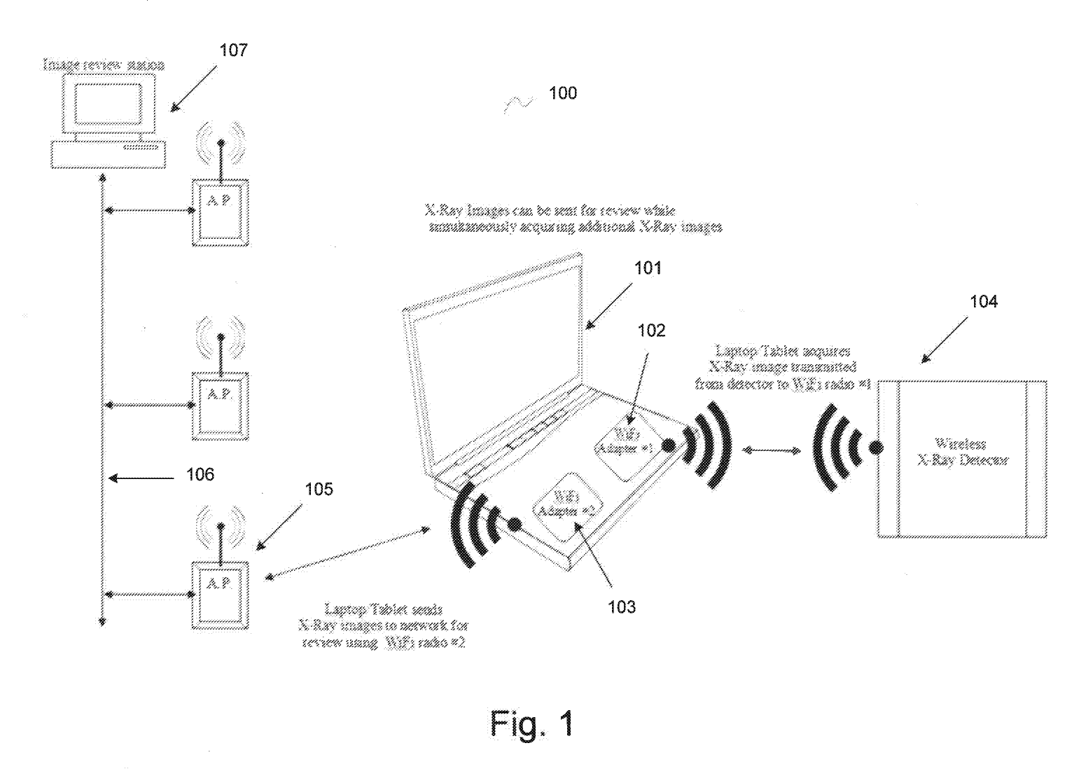

FIG. 1 is a representational view illustrating a general configuration of a system 100 according to an exemplary embodiment. For discussion purposes, system 100 represents a wireless X-ray imaging system. System 100 includes, but is not limited to, mobile processing device 101, wireless X-ray detector 104, access point 105, network 106, and image review station 107. While illustrated as a laptop, mobile processing device 101 can be any type of mobile device, e.g., a tablet, which would enable practice of the present disclosure. Mobile processing device 101 includes internal wireless adapter #1 102 and internal wireless adapter #2 103, where both internal wireless adapter #1 102 and internal wireless adapter #2 103 are internally installed in mobile processing device 101.

In the present exemplary embodiment, internal wireless adapter #1 102 and internal wireless adapter #2 103 both conform to known Wi-Fi® standards. Both internal wireless adapter #1 102 and internal wireless adapter #2 103 can be dual band adapters, where each adapter can operate at the same band as the other or a different band from the other. Internal wireless adapter #1 102 and internal wireless adapter #2 103 are not limited to the Wi-Fi® standards and can conform to any wireless communication standard, e.g., Bluetooth®, Near Field Communication (NFC), that would enable practice of the present disclosure.

Mobile processing device 101 is wirelessly connected to wireless X-ray detector 104 via internal wireless adapter #1 102 and to access point 105 via internal wireless adapter #2 103. Digital X-ray images can be acquired via internal wireless adapter #1 102 from wireless X-ray detector 104 while any previously acquired images can simultaneously be sent via internal wireless adapter #2 103 to access point 105. These images can then be forwarded via network 106 to image review station 107, where, for example, a doctor can receive and view them while an X-ray technologist is still performing exams and acquiring X-ray images. Thus, a doctor will not need to wait for the X-ray technologist to complete all of the exams before receiving X-ray images for review. For discussion purposes, network 106 is a Digital Imaging and Communications in Medicine (DICOM) network, but any type of network that supports handling, storing, printing and transmitting medical imaging information is applicable.

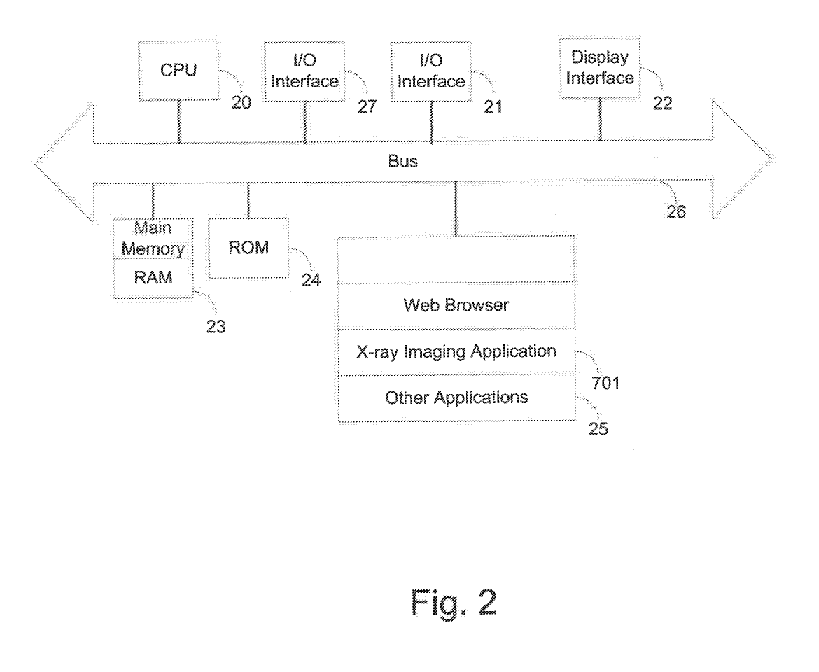

FIG. 2 is block diagram illustrating a general configuration of the internal architecture of mobile processing device 101 according to an exemplary embodiment. Mobile processing device 101 includes at least one processor (CPU) 20, which can be any type of microprocessor, I/O interface 21 and I/O interface 27 for communicating with other devices, networks, etc., and display interface 22 for interfacing with a display (not shown) of the mobile processing device.

Read only memory (ROM) 24 stores invariant computer-executable process steps for basic system functions such as basic I/O, start-up, etc. Main random access memory (RAM) 23 provides CPU 20 with memory storage that can be accessed quickly. In this regard, computer-executable process steps of an X-ray imaging application, as well as other applications, are transferred from storage 25 over bus 26 to RAM 23 and executed therefrom by CPU 20.

The memory can include one or more computer-readable or computer-writable storage media. A computer-readable storage medium, as opposed to mere transitory, propagating signals, includes a tangible article of manufacture, for example, a magnetic disk, e.g., hard disk, floppy disk, an optical disc, e.g., CD, DVD, etc., magneto-optical disk, magnetic tape, or semiconductor memory, e.g., non-volatile memory, flash memory, solid-state drive, SRAM, DRAM, EPROM, EEPROM, etc.

Storage 25, which, in addition to the X-ray imaging application, includes an operating system, a web browser, and other applications that enable the mobile processing device to provide a multitude of different functions.

The above-described components illustrated in FIG. 2 are provided for example purposes only. The mobile processing device of the present disclosure need not include all of the described components, can include additional components, and any configuration enabling practice of the present disclosure is applicable.

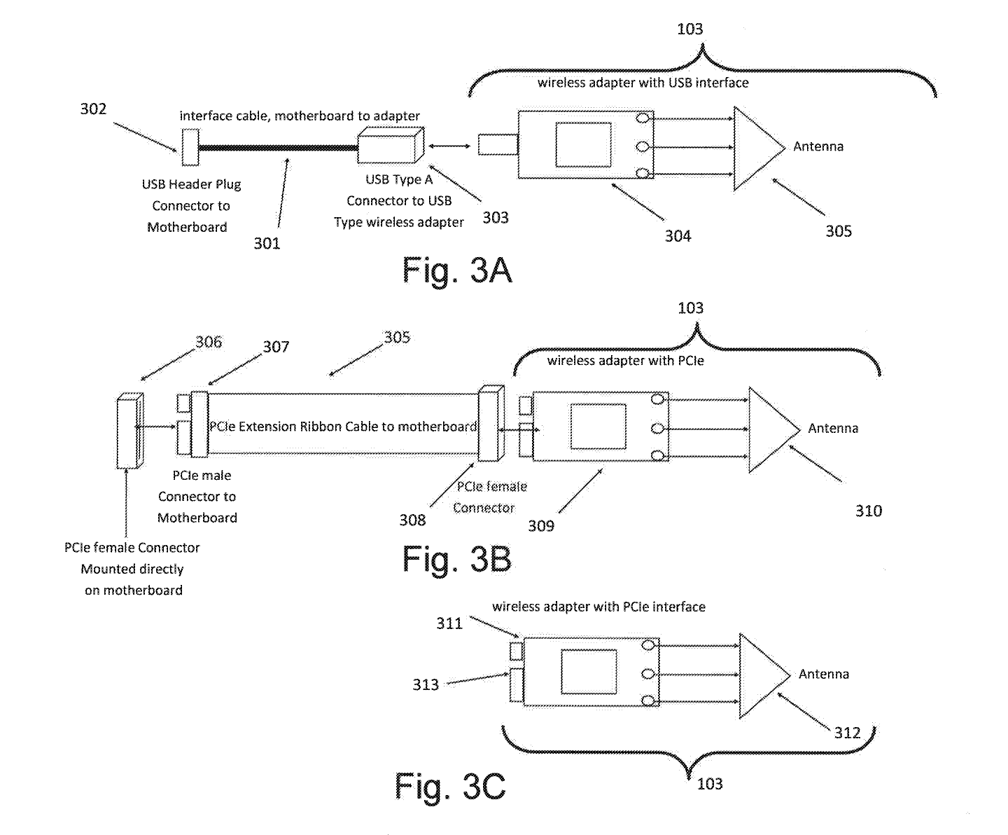

FIGS. 3A-3C are block diagrams illustrating different methods for interfacing a second internal wireless adapter with mobile processing device 101 according to an exemplary embodiment. For discussion purposes, the depicted configurations reflect interfacing with a notebook or tablet as the mobile processing device. However, any type of mobile processing device that would enable practice of the present disclosure is applicable.

FIG. 3A illustrates a configuration for interfacing internal wireless adapter #2 103 with mobile processing device 101 utilizing an interfacing cable that includes a universal serial bus (USB) Header plug and a USB Type A connector. Antenna 305 is secured to the wireless radio board 304 to create internal wireless adapter #2 103. Interface cable 301, which connects the motherboard (not illustrated) of mobile processing device 101 with wireless radio board 304, includes USB Header plug connector 302, which connects to a USB Header plug (not illustrated) on the motherboard, and USB Type A Connector to USB Type wireless adapter 303. Wireless radio board 304 includes a USB interface that connects to USB Type A Connector to USB Type wireless adapter 303, which enables internal wireless adapter #2 103 to interface to mobile processing device 101, thus providing mobile processing device 101 with a second internal wireless interface.

FIG. 3B illustrates a configuration for interfacing internal wireless adapter #2 103 with mobile processing device 101 utilizing a peripheral component interconnect express (PCIe) interface. PCIe type Wi-Fi radio board 309 with antenna 310 secured to it constitutes internal wireless adapter #2 103. Internal wireless adapter #2 103 connects to a PCIe female connector 308 of a PCIe extension ribbon cable 305. PCIe extension ribbon cable 305 connects to a PCIe female connector 306 mounted to the motherboard (not illustrated) of mobile processing device 101 via PCIe male connector 307. This enables internal wireless adapter #2 103 to interface to mobile processing device 101, thus providing mobile processing device 101 with a second internal wireless interface.

FIG. 3C illustrates a configuration for interfacing internal wireless adapter #2 103 with mobile processing device 101 utilizing a direct peripheral component interconnect express (PCIe) interface. PCIe type Wi-Fi radio board 311 with antenna 312 secured to it constitutes internal wireless adapter #2 103. Internal wireless adapter #2 103 connects directly to the motherboard of mobile processing device 101 via PCIe connector 313. This enables internal wireless adapter #2 103 to interface to mobile processing device 101, thus providing mobile processing device 101 with a second internal wireless interface.

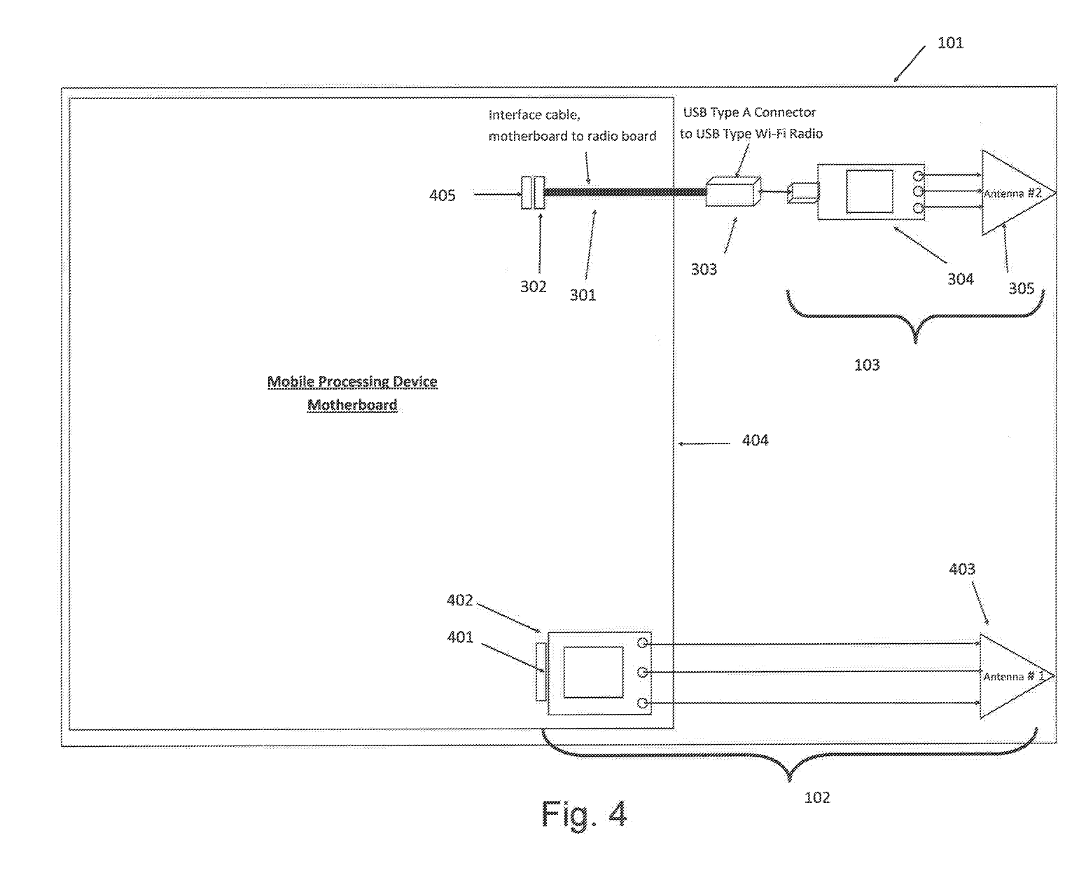

FIG. 4 is a block diagram illustrating a general configuration of a mobile processing device with two internal wireless interface adapters according to an exemplary embodiment. The reference numbers for components previously described are repeated in FIG. 4 and descriptions of those components are not repeated herein. Internal wireless adapter #1 102 includes antenna #1 403 secured to wireless radio #1 402. Internal wireless adapter #1 is connected to a PCIe connector (not illustrated) on motherboard 404 of mobile processing device 101 via PCIe connector 401 of wireless radio #1 402. Internal wireless adapter #2 103 interfaces with motherboard 404 via USB Header plug 405 using the configuration of FIG. 3A as described above.

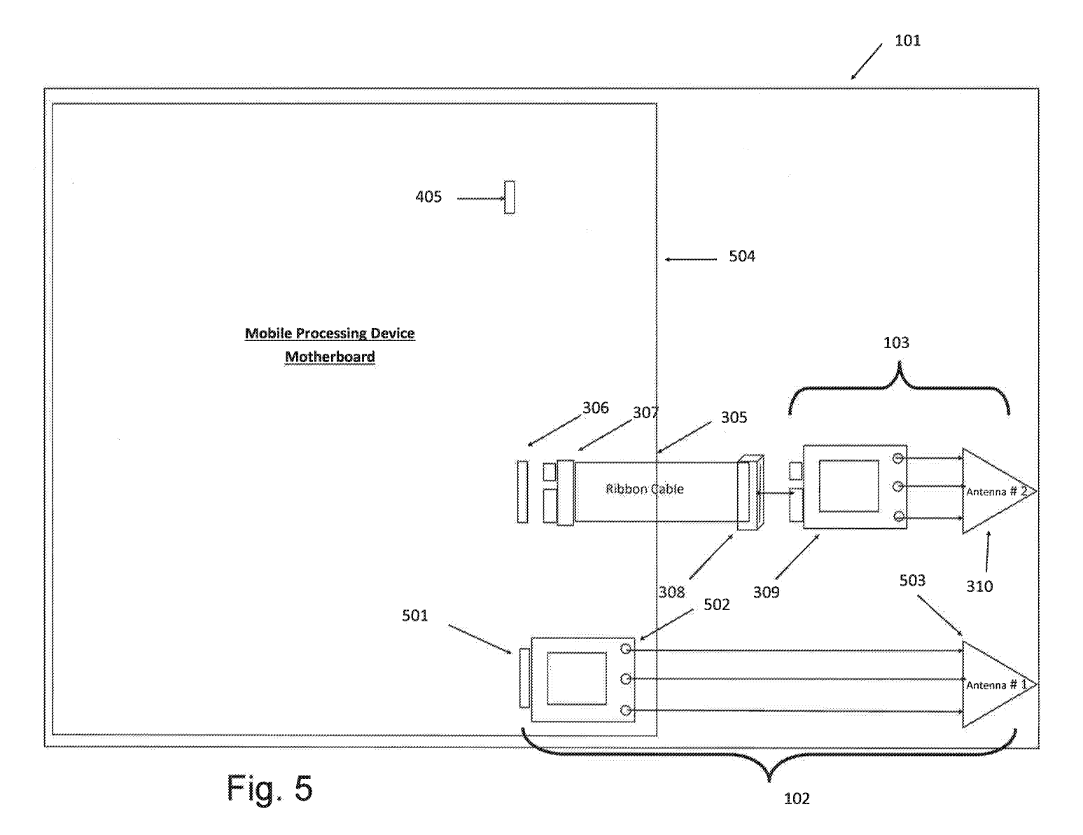

FIG. 5 is a block diagram illustrating a general configuration of a mobile processing device with two internal wireless interface adapters according to an exemplary embodiment. The reference numbers for components previously described are repeated in FIG. 5 and descriptions of those components are not repeated herein. Internal wireless adapter #1 102 includes antenna #1 503 secured to wireless radio #1 502. Internal wireless adapter #1 is connected to a PCIe connector (not illustrated) on motherboard 504 of mobile processing device 101 via PCIe connector 501 of wireless radio #1 502. Wireless adapter #2 103 interfaces with motherboard 504 via PCIe female connector 306 using the configuration of FIG. 3B as described above.

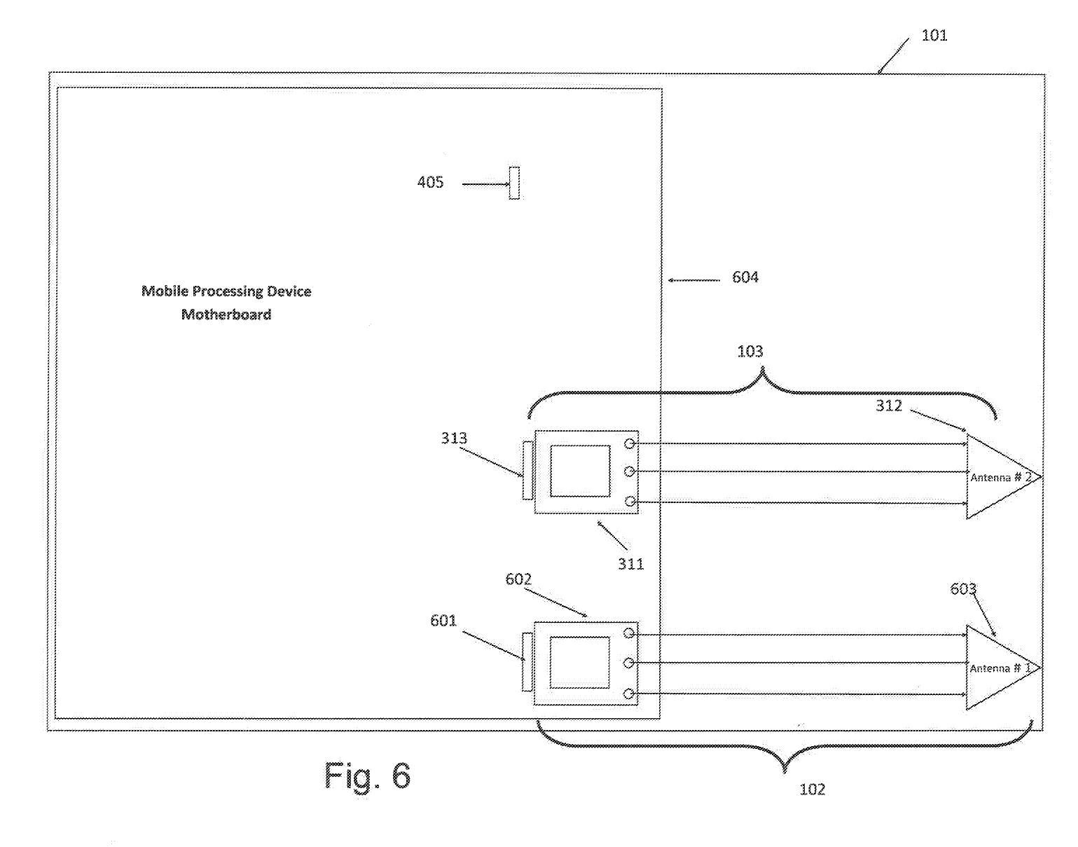

FIG. 6 is a block diagram illustrating a general configuration of a mobile processing device with two internal wireless interface adapters according to an exemplary embodiment. The reference numbers for components previously described are repeated in FIG. 6 and descriptions of those components are not repeated herein. Internal wireless adapter #1 102 includes antenna #1 603 secured to wireless radio #1 602. Internal wireless adapter #1 102 is connected to a PCIe connector (not illustrated) on motherboard 604 of mobile processing device 101 via PCIe connector 601 of wireless radio #1 602. Internal wireless adapter #2 103 connects to a PCIe connector (not illustrated) on motherboard 604 of mobile processing device 101 via PCIe connector 313.

In a wireless X-ray imaging system, each of the configurations illustrated in FIGS. 4-6 enable mobile processing device 101 to use a first internal wireless interface (internal wireless adapter #1 102) to interface/communicate with wireless X-ray detector 104 and second internal wireless interface (internal wireless adapter #2 103) to interface/communicate with access point 105 on a hospital network (network 106). This facilitates a parallel operation of acquiring X-ray images while sending the acquired X-ray images for review.

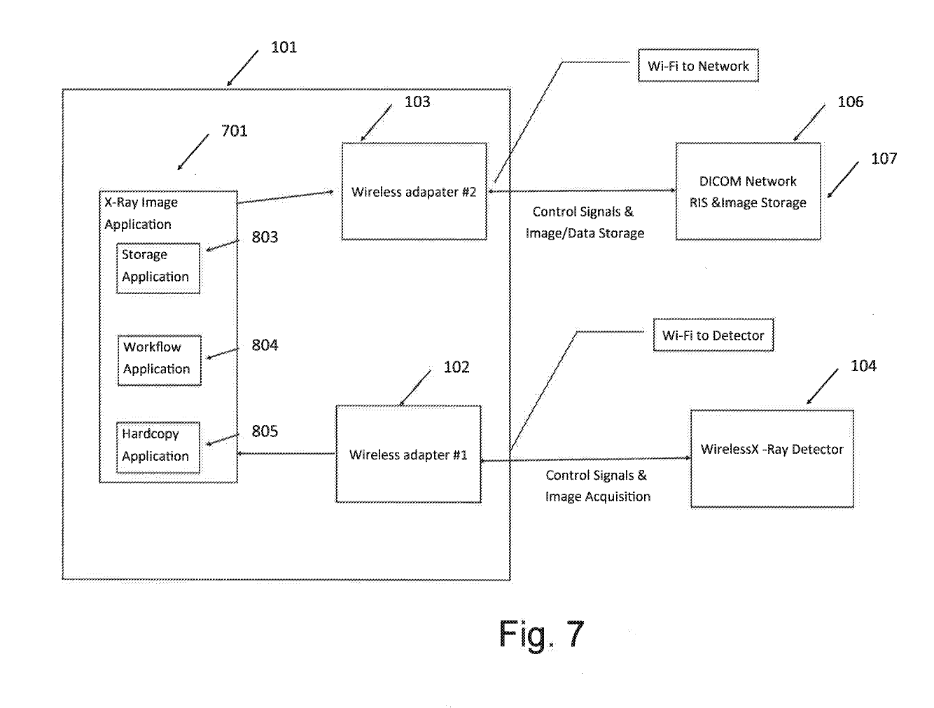

FIG. 7 illustrates a general data and control flow of the system according to an exemplary embodiment. In an exemplary flow, X-ray imaging application 701 facilitates acquisition of X-ray images by mobile processing device 101 from wireless X-ray detector 104 via internal wireless adapter #1 102. X-ray imaging application 701 also facilities transmission of X-ray images from mobile processing device 101 to network 106 via internal wireless adapter #2 103.

X-ray imaging application 701 includes Storage Application 803, Workflow Application 804, and Hardcopy Application 805 to support acquisition and transfer of X-ray images and associated information/data. Each of these applications are described in more detail below. X-ray imaging application 701 receives and transmits X-ray images in parallel via internal wireless adapter #1 102 and internal wireless adapter #2 103 respectively as described in more detail below.

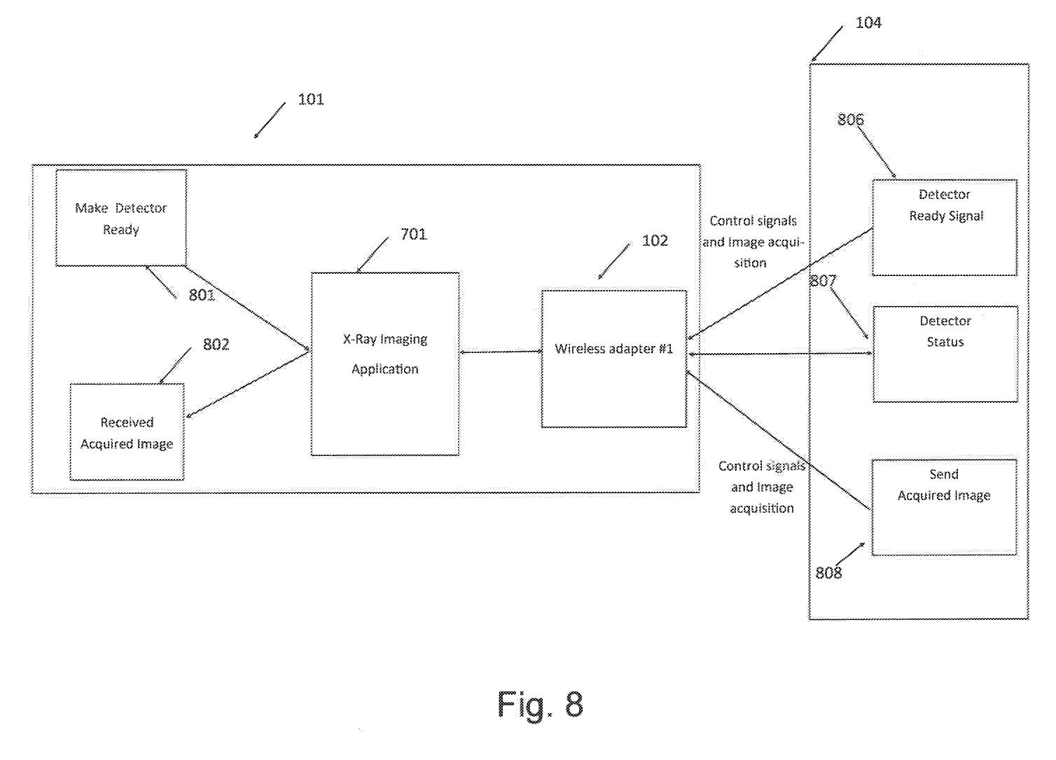

FIG. 8 illustrates a data and control flow between the mobile processing device and another device using an internal wireless interface adapter according to an exemplary embodiment. More specifically, FIG. 8 illustrates the data and control flow between mobile processing device 101 and wireless X-ray detector 104.

As previously described, X-ray image application 701 facilitates the interface between mobile processing device 101 and wireless X-ray detector 104 via internal wireless adapter #1 102. X-ray image application 701 includes Make Detector Ready 801 and Received Acquired Image 802. Make Detector Ready 801 enables a user of mobile processing device 101 to prepare wireless detector 104 for operation. Received Acquired Image 802 enables a user of mobile processing device 101 to confirm that an X-ray image was acquired from wireless X-ray detector 104 during a specific X-ray exam.

Wireless X-ray detector 104 includes Detector Ready Signal 806, Detector Status 807, and Send Acquired Image 808. Detector Ready Signal 806 provides a signal to mobile processing device 101 whether wireless X-ray detector 104 is in a ready-to-use state. Detector Status 807 provides a status of the detector 104. Send Acquired Image 808 sends X-ray images acquired by wireless X-ray detector 104 to mobile processing device 101.

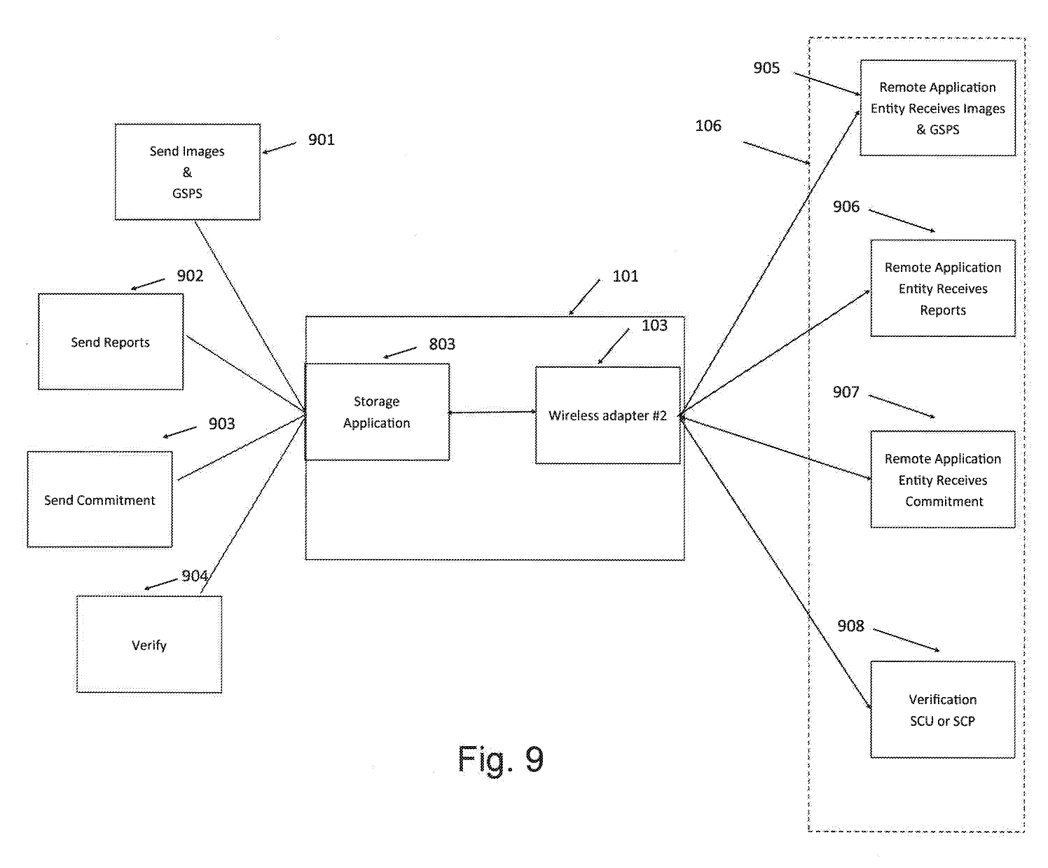

FIG. 9 illustrates a data storage flow of the system according to an exemplary embodiment. More specifically, FIG. 9 illustrates an exemplary flow of mobile processing device 101 storing data and other information on network 106. The data and information is transmitted from mobile processing device 101 to network 106 via internal wireless adapter #2 103.

Storage application 803 includes Send Images & GSPS 901, Send Reports 902, Send Commitment 903, and Verify 904. Send Images & GSPS 901 enables mobile processing device 101 to send X-ray images acquired from wireless X-ray detector 104 to network 106. Send Reports 902 enables mobile processing device 101 to send X-ray imaging related reports to network 106. Send Commitment 903 provides mobile processing device 101 with the ability to confirm with network 106 that transmitted X-ray images have been stored on network 106 and can be removed from the mobile processing device 101. Verify 904 is used by mobile processing device 101 to authenticate itself with network 106.

Network 106 includes Remote Application Entity Receives Images & GSPS 905, Remote Application Entity Receives Reports 906, Remote Application Entity Receives Commitment 907, and Verification SCU or SCP 908. In the present exemplary embodiment, each of these is implemented in image review station 107. However, this is not seen to be limiting, and each can be implemented in any applicable device connected to network 106.

Remote Application Entity Receives Images & GSPS 905 is used by image review station 107 to receive X-ray images transmitted to network 106 by mobile processing device 101. Remote Application Entity Receives Reports 906 is used to receive report related information transmitted to network 106 by mobile processing device 101. Remote Application Entity Receives Commitment 907 is used by network 106 to receive commitment requests from mobile processing device 101 and provide a response, e.g., received X-ray image data stored and can be removed from device. Verification Service Class User (SCU) or Service Class Provider (SCP) 908 is used by network 106 as part of mobile processing device 101 authenticating itself to network 106 and network 106 authenticating itself to mobile processing device 101.

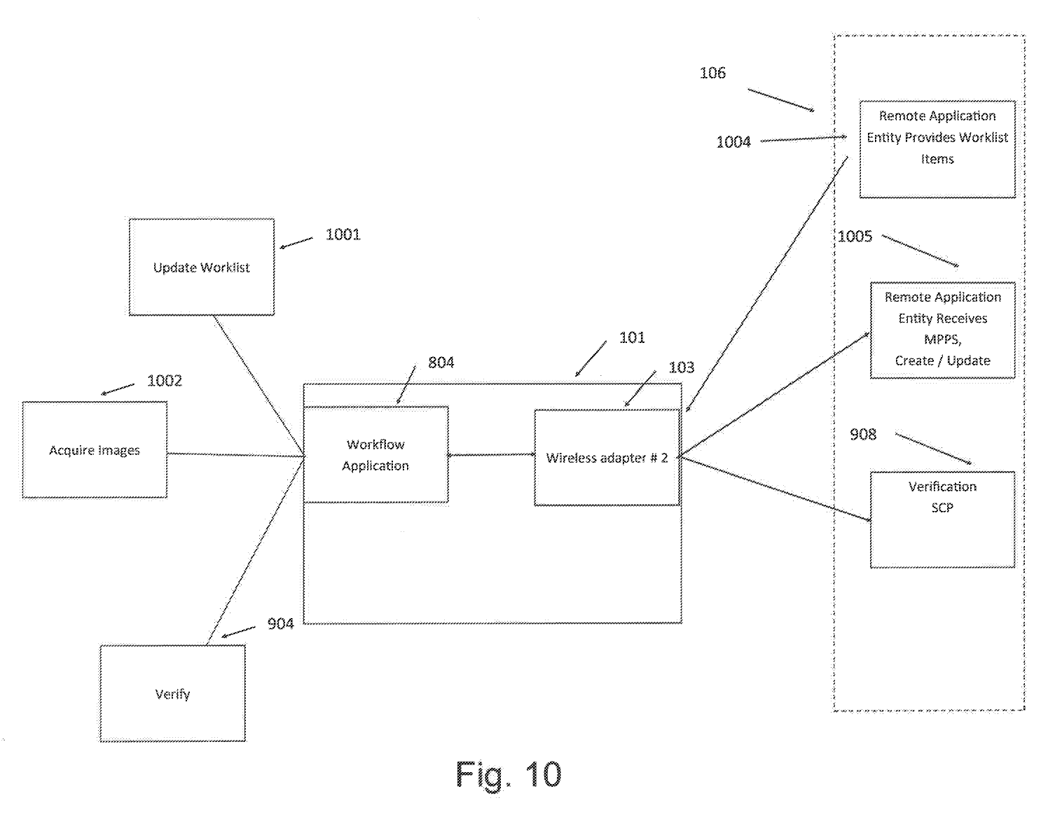

FIG. 10 illustrates a workflow of the system according to an exemplary embodiment. More specifically, FIG. 10 illustrates an exemplary flow of mobile processing device 101 receiving X-ray work orders from network 106.

Workflow Application 804 includes Update Worklist 1001, Acquire Images 1002, and Verify 904. Update Worklist 1001 maintains and updates a current list of X-ray imaging orders stored in mobile processing device 101 based on information provided from network 106 via internal wireless adapter #2 103. Acquire Images 1002 facilitates acquisition of X-ray images by mobile processing device 101 from wireless X-ray detector 104 via internal wireless adapter #1 102.

Network 106 includes Remote Application Entity Provides Worklist Items 1004, Remote Application Entity Receives MPPS, Create/Update 1005, and Verification Service Class Provider (SCP) 908. In the present exemplary embodiment, each of these is implemented in image review station 107. However, this is not seen to be limiting, and each can be implemented in any applicable device connected to network 106.

Remote Application Entity Provides Worklist Items 1004 generates X-ray orders submitted by, for example, a doctor, which are then transmitted to mobile processing device via internal wireless adapter #2 103. Remote Application Entity Receives MPPS (Modality Performed Procedure Step), Create/Update 1005 enables network 106 to receive information from mobile processing device 101 regarding imaging the mobile processing device 101 is performing.

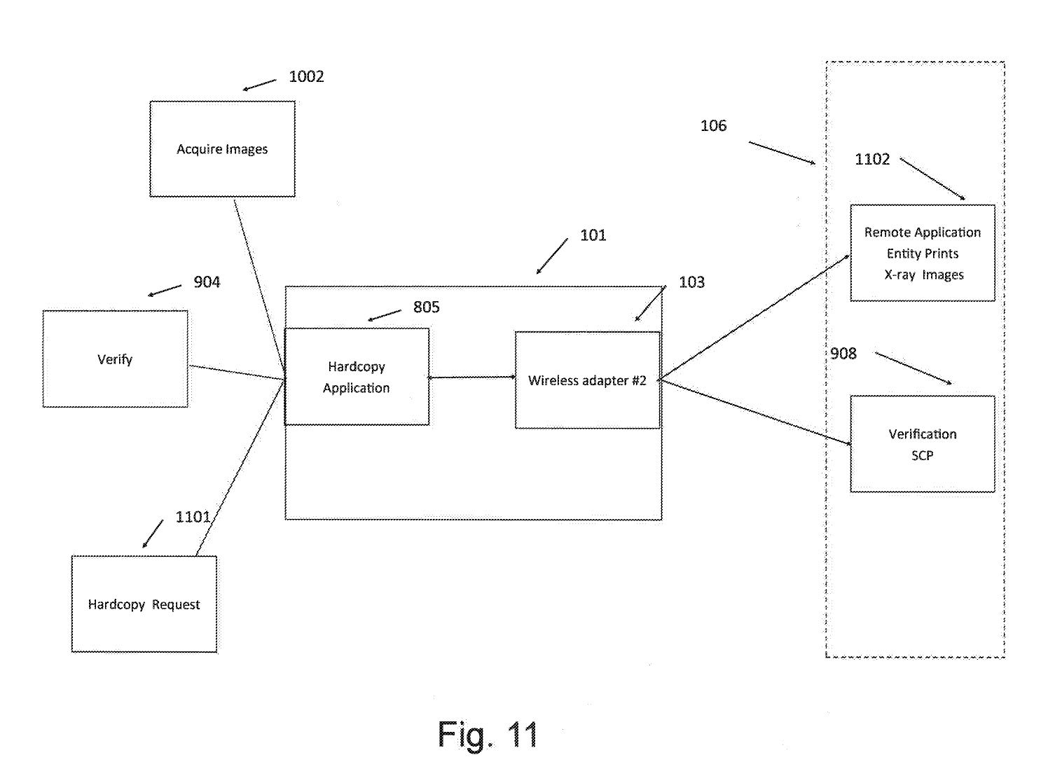

FIG. 11 illustrates a flow for obtaining hardcopies of data according to an exemplary embodiment. More specifically, FIG. 11 illustrates an exemplary flow of mobile processing device 101 initiating printing of acquired X-ray images and other information on network 106.

Hardcopy Application 805 includes Acquire Images 1002, Verify 904, and Hardcopy Request 1101. Hardcopy Request 1101 is used to generate a request that mobile processing device 101 transmits to network 106, via internal wireless adapter #2 103, to print copies of acquired X-ray images.

Network 106 includes Remote Application Entity Prints X-ray Images 1102 and Verification Service Class Provider (SCP) 908. In the present exemplary embodiment, each of these is implemented in image review station 107. However, this is not seen to be limiting, and each can be implemented in any applicable device connected to network 106. Remote Application Entity Prints X-Ray Images 1102 is used to print copies of X-ray images based on the request transmitted by mobile processing device 101.

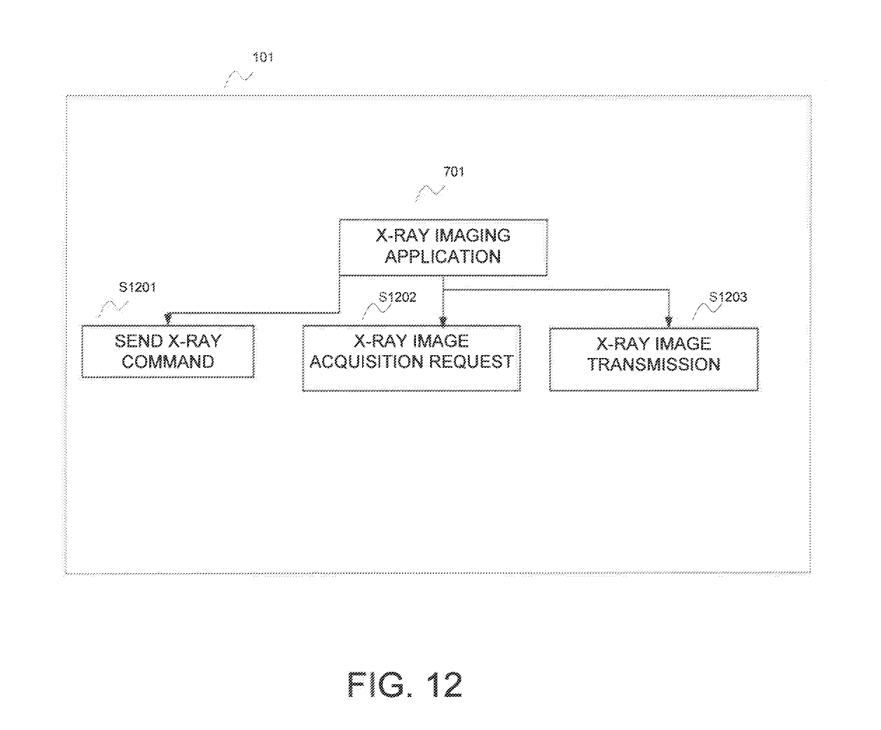

FIG. 12 illustrates a parallel data acquisition and transmission process according to an exemplary embodiment. More specifically, FIG. 12 illustrates the parallel process implemented by X-ray imaging application 701 of obtaining X-ray images from wireless X-ray detector 104 using internal wireless adapter #1 102 and transmitting acquired X-ray images to network 106 using internal wireless adapter #2 103, as previously referenced with respect to FIGS. 7, 8, and 9.

In step S1201, X-ray imaging application 701 issues a command to cause wireless X-ray detector 104 to initiate the process of capturing an X-ray image of a patient. The command is sent for each X-ray image event included in a worklist provided to the mobile processing device 101 from Remote Application Entity Provide Worklist items 1004.

In step 1202, X-ray imaging application 701 issues an X-ray image acquisition request to wireless X-ray detector 104. X-ray detector 104, using Send Acquired Image 808, sends the requested X-ray image to the mobile processing device 101 via internal wireless X-ray adapter #1 102. X-ray application 701 re-sends the X-ray image acquisition request for each additional X-ray image to be acquired. Send Acquired Image 808 sends each of the additional requested X-ray images to the mobile processing device 101.

As illustrated in FIG. 12, in parallel to sending an X-ray image acquisition request to wireless X-ray detector 104 via internal wireless adapter #1 102, X-ray imaging application 701 transmits an acquired X-ray image to network 106 via internal wireless adapter #2 103. The use of internal wireless adapter #1 102 and internal wireless adapter #2 103 by X-ray imaging application 701 to acquire X-ray images from wireless X-ray detector 104 while sending previously acquired X-ray images to network 106 in parallel enables doctors to receive X-ray images and begin reviewing the received X-ray images while a technologist is still performing exams and acquiring X-ray images.

The scope of the present disclosure includes a computer-readable storage medium storing computer executable instructions which, when executed by one or more processors, cause the one or more processors to perform one or more of the above-described exemplary embodiments. Examples of a computer-readable storage medium include, but are not limited to, a floppy disk, a hard disk, a magneto-optical disk (MO), a compact-disk read-only memory (CD-ROM), a compact disk recordable (CD-R), a CD-Rewritable (CD-RW), a digital versatile disk ROM (DVD-ROM), a DVD-RAM, a DVD-RW, a DVD+RW, magnetic tape, a nonvolatile memory card, and a ROM. Computer-executable instructions can also be supplied to the computer-readable storage medium by being downloaded via a network.

While the present disclosure has been described with reference to exemplary embodiments, it is to be understood that these exemplary embodiments are not seen to be limiting. The scope of the following claims is to be accorded the broadest interpretation so as to encompass all such modifications and equivalent structures and functions.

What is claimed is:

1. A mobile processing device comprising:
a first wireless interface, installed internally in the mobile processing device, in communication with an external device;
a second wireless interface, installed internally in the mobile processing device, in communication with a network; and
a control unit that controls the first wireless interface to acquire data from the external device and the second wireless interface to transmit the acquired data to the network, wherein acquisition of the data and transmission of the acquired data occur in parallel.
